(19) United States
(12) Patent Application Publication
(10) Pub. No.: US 2021/0369550 A1
(43) Pub. Date: Dec. 2, 2021

(54) Device for testicle stimulation

(71) Applicant: Taylor Jacob Marchand, Santa Rosa, CA (US)

(72) Inventor: Taylor Jacob Marchand, Santa Rosa, CA (US)

(21) Appl. No.: 16/888,657

(22) Filed: May 29, 2020

(51) Int. Cl. A61H 19/00

(52) U.S. Cl. CPC A61H 19/32; A61H 2201/165; A61H 2201/1654; A61H 2201/0192; A61H 2201/1645; A61H 2201/0173

(57) ABSTRACT

Disclosed herein is a device that compresses the testicles between two ergonomically-shaped plates in order to produce a sexual response. The plates are ergonomically sculpted to fit flush against the contours of the wearer's crotch, thereby reducing negative affects of the device on the wearer's mobility and comfort.

The ergonomic plates are connected together to form the testicle vice by means of an integrated quick-disconnect hinge. The hinge is a slip-joint style hinge whose components are incorporated into the design of the plates, i.e. no additional hardware is required to form the hinge.

The plates are compressed together by means of a single tensioner. The tensioner is an adjustment screw which is threaded into a pivoting nut on the base plate (also referred to herein as the “stationary jaw”). The head of the screw acts as the latch, which is secured onto the top plate (also referred to herein as the “moveable jaw”) by means of a catch plate. The adjustment screw acts as the vise's slide, whereto the moveable jaw travels along the slide's axis. The screw can pivot around the pivoting nut's axis, retracting away from the latch's receptacle (herein referred to as the “catch plate”), thereby allowing a quick release of the vice's pressure.

An orifice in the base plate is large enough to insert both the penis and testicles. A smaller orifice in the top place prevents insertion of the testicles but allows insertion of the penis, thereby isolating the testicles within the vice's jaws. A vertical ridge in the middle of the stationary jaw divides the testicles into two separate compartments (also referred to herein as “testicle cups”), aligning the testes parallel to the vice's jaws.

### REFERENCES CITED

| | | |
|---|---|---|
| 8926428 | Jan. 6, 2015 | Weng, et al. |
| 10070986 | Sep. 11, 2018 | Parmet, et al. |
| 10076437 | Sep. 18, 2018 | Plath |
| 5845642 | Dec. 8, 1998 | Vanmoor |
| 6289895 | Sep. 18, 2001 | Cheng (Cheng, et al.) |
| 9943663 | Apr. 17, 2018 | Vasapollo |
| 10105279 | Oct. 23, 2018 | Kaiya |
| 10123933 | Nov. 13, 2018 | Shao |
| 9901509 | Feb. 27, 2018 | Abramovitz |

### OTHER REFERENCES

Example of American retail offering of a similar device, “Penis And Testicle Crusher”, <URL: https://www.amazon.com/Master-MO106-Penis-Testicle-Crusher/dp/B008WEP5HE/ref=pd_lpo_sbs_1212_0?_en coding=UTF8&psc=1&refRID=75AVEMWQEDS865304CY5>, Jun. 23, 2019. cited by applicant.

Example of current Asian retail offering of a similar device, “CBT Cock And Ball Crusher”, <URL: https://www.dhgate.com/product/the-acrylic-cock-and-ball-crusher/371049813.html>, Mar. 1, 2016. cited by applicant.

Example of current European retail offering of a similar device, “Cock And Ball Crusher”, <URL: https://www.uberkinky.co.uk/dr-sado-cock-ball-crusher-80283.html>, Jun. 23, 2019. cited by applicant.

### BACKGROUND

Most testicle compression devices are designed with a lack of ergonomics. The top plate and base plate of these designs are flat planes, utilizing simple geometric shapes that do not have a natural fit to the wearer. These inorganic designs inherently lay in an unnaturally raised position, tangent to the anterior-most points of the wearer's crotch. This lack of ergonomics orients these devices significantly far from the testicles. When correctly worn, these designs pull the testicles away from the body and stretch the scrotum. It is desirable to create a similar but improved device that sits flush against the wearer's body. By incorporating ergonomic contours of the crotch into this new design, the device will lay flat, i.e. adjacent—to rather than tangent—from the wearer's body, so that pulling and stretching of the scrotum is minimized.

The inorganic shape of most testicle compression devices leads to a second phenomenon in which the wearer has reduced mobility of their legs. The lower corners of these devices are situated along the wearer's thighs, causing the corners to poke and prod the quadriceps. The rounded corners of these devices have a relatively small, sharp radius, lending themselves to excoriate the wearer's skin. This is unnecessary discomfort, and the potential for injury is enough to discourage a wearer from moving their legs while wearing these devices. It is desirable to create a similar but improved device where the corners nearest the legs are blunted, so as not to hamper the mobility and ambulation of the wearer.

As most testicle compression devices require that the wearer insert their genitals through each plate's orifice, one plate at a time, and that most of these devices have fixed, permanent hinges connected to the plates, it can be difficult to apply these devices in the one-plate-at-a-time sequence. The top plate can be unwieldy; swinging about uncontrollably, or simply interfere with the wearer while they attempt to affix the base plate around the genitals. It is desirable to create a similar but improved device where the top plate and base plate can be disconnected, as the wearer may find it easier to insert the genitals through the base plate prior to connecting the top plate to the vice's assembly.

As the testicles are considerably one of the most sensitive areas of the body, overuse of testicle compression devices can turn from enjoyable to unbearable in an instant. Most testicle compression devices require the wearer to unscrew a plurality of adjusting screws to relieve the vise's pressure. This process is inefficient and slow. It is desirable to create a similar but improved device that uses a single tensioner to engage the vise's action, thereby significantly reducing the time it takes to relieve the vice's pressure.

Most testicle compression devices have adjusting screws that do not easily unlatch the top plate from the base plate. These screws either require two-handed operation (to fasten the nut while holding the bolt), which is unwieldy and inefficient, or, in other embodiments, the screw is fixed to the base plate in a permanent, rigid position, which requires the nut to be completely unscrewed from the bolt before the vise may be opened. In either case, it is desirable to create an apparatus that tensions the vise with a one-handed operation, and may also be capable of quickly releasing the vise's tension.

### SUMMARY

Disclosed herein is a device that affects the wearer's arousal state by means of compressing the testicles. The device's overall design is an ergonomically-contoured vise. The device consists of two plates which are hinged together to form the vise. The top plate articulates around the hinge's axis to press the testicles into the base plate. The device is worn around the male genitalia, where the penis and testicles are inserted through the base plate, and the penis is inserted through the top plate, thereby isolating the testicles between the two plates.

The device is ergonomically contoured to reduce collision with the wearer's thighs, lower abdomen and crotch, thereby minimizing negative effects on the wearer's comfort, mobility and ambulation.

The device's hinge is a quick-disconnect interlocking slip-joint hinge. The hinge components are integrated into the plates design, where the top plate contains the male hinge components, and the base plate contains the female hinge components. The male hinge components include the top plate (also referred to herein as the “male hinge leaf”), male hinge knuckles, and male hinge pins. The female hinge components include the base plate (also referred to herein as the “female hinge leaf”), a pin alignment track (also referred to herein as the ‘horizontal assembly guide’), hinge-knuckle gates and gate curbs, and hinge cups.

The quick-disconnect hinge interlocks when properly assembled. This slip-joint hinge has a female pin alignment track which escorts the male hinge pins into the female hinge cups, and then the male hinge knuckles are rotated within the female hinge knuckle gates to create a locked position, which ensures the plates cannot be accidentally separated during operation.

The plates are compressed by means of a single tensioning apparatus. The tensioner is an adjustment screw. The screw threads into the base plate by means of a clevis pivot bracket, while the head of the screw latches onto the top plate's catch plate. The tensioner is mounted onto a pivot on the base plate, allowing the tensioning apparatus to quickly rotate away from the top plate's catch plate. The pivoting design of this tensioning system allows the vice's tension to be quickly released.

The device has a protrusion which divides the testicles into separate compartments in between the vise.

A further understanding of the nature and advantages of the present invention may be realized by reference to the remaining portions of the specification and the drawings.

### DESCRIPTION

### Technical Field

This invention relates to sexual stimulation devices and more particularly to devices that affect the wearer's arousal state by inserting their genitals therein.

### BRIEF DESCRIPTION OF THE DRAWINGS

FIG. 1A is an illustrative diagram of the fully assembled device 501, viewed from the trimetric perspective, 1:0.75 scale. In this projection the top plate 101 is interlocked with the base plate 103, as the male hinge knuckles 203, FIG. 2A are rotated inside the female hinge knuckle gates 215, FIG. 2B.

FIG. 1B is an illustrative diagram showing the fully assembled device 501, viewed from the dimetric perspective, 1:0.75 scale, where the top plate 101 and base plate 103 are fully closed (herein referred to as the ‘collateral position’).

FIG. 2A is an illustrative diagram of the top plate 101, viewed from the anterior coronal plane, 1:0.75 scale. The male hinge pins 201 are connected to the top plate's body 805, FIG. 8B by means of hinge knuckles 203. When the assembled device 501 is in the collateral position, the male hinge knuckles 203 and male hinge leaf 805, FIG. 8B tessellate with the horizontal assembly guide 605 and female gate curbs 217, FIG. 2B, forming a flush union. When the device is assembled and the plates 101 & 103 are interlocked, the female gate curbs 217 prevent the top plate from lateral shifting and thereby accidentally disassembling during operation.

221, FIG. 2B is pointing out the superior edge of the base plate 103 for further referencing within this document.

The illustration in 209, FIG. 2B is a depiction of ambulo-ergonomic contouring, where the inferior corners are shaped with a logarithmic curve.

FIGS. 3A-3B, are cross sections illustrating both the general design and connectivity of the interlocking slip-joint hinge 301, and also the internal structure of the clevis pivot bracket 211 and the catch plate body 213, viewed from the isometric perspective, 1:0.75 scale.

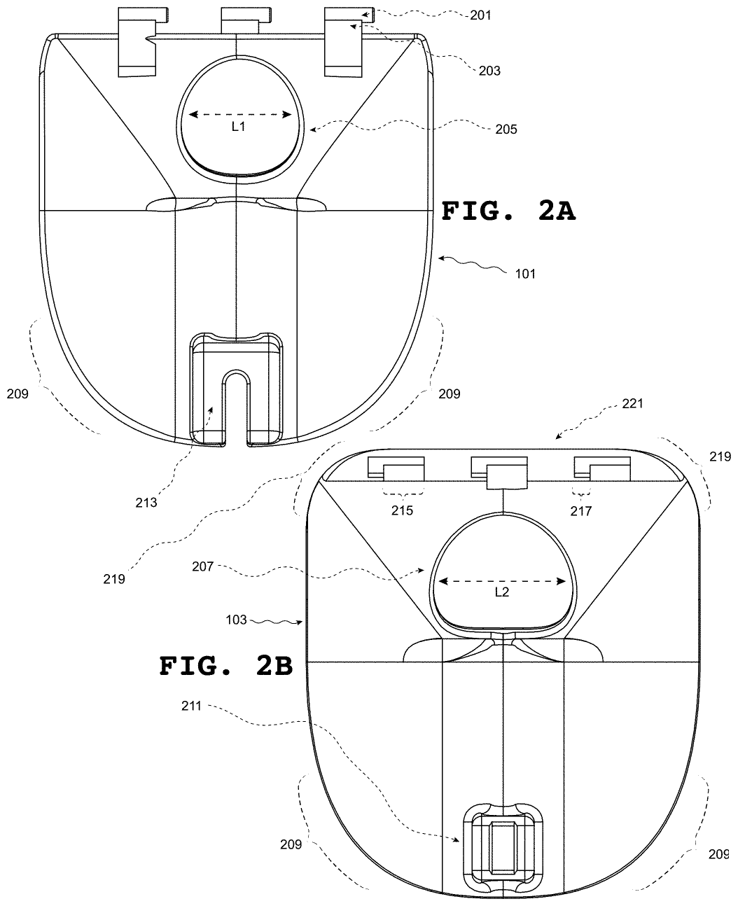

The major orifice 207, FIG. 2B of the genital collar 901, FIG. 9A allows the penis and testicles to pass through the base plate 103, while the minor orifice 205, FIG. 2A of the penile collar 903, FIG. 9B allows only the penis to pass through the top plate 101, thereby isolating the testicles between the plates. The size L1 of the minor orifice 205 is lesser than the size L2 of the major orifice 207.

FIG. 2A-2B are illustrative diagrams of ambulo-ergonomic contouring 209 of the top plate 101 and base plate 103, where the blunted corners reduce collision with the wearer's thighs and reduce inhibiting effects on the wearer's mobility and ambulation. The clevis pivot bracket 211, as part of the tensioning system 603, FIG. 6B houses the barrel nut 107, where the adjusting screw 105 threads into the barrel nut 107, FIG. 6B and pivots around the nut's axis. The adjusting screw's head 401, FIG. 4A serves as the latch hook, and the adjusting screw's threaded shaft 403 serves as the latch arm. The latch's catch plate body 213, FIG. 2A, receives the latch hook 401, FIG. 4A and secures it by means of a retrocline lip 803, FIG. 8A.

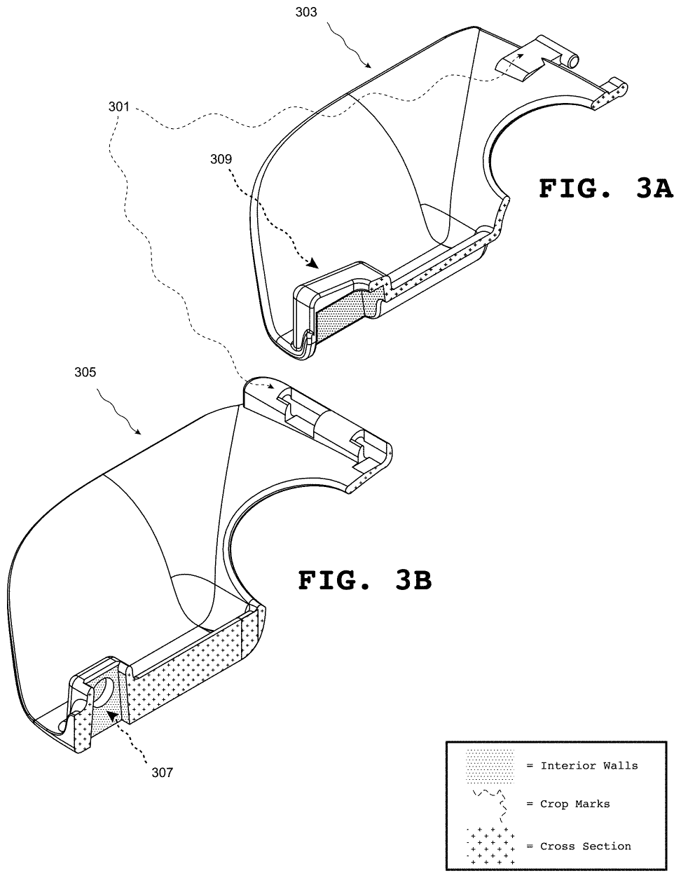

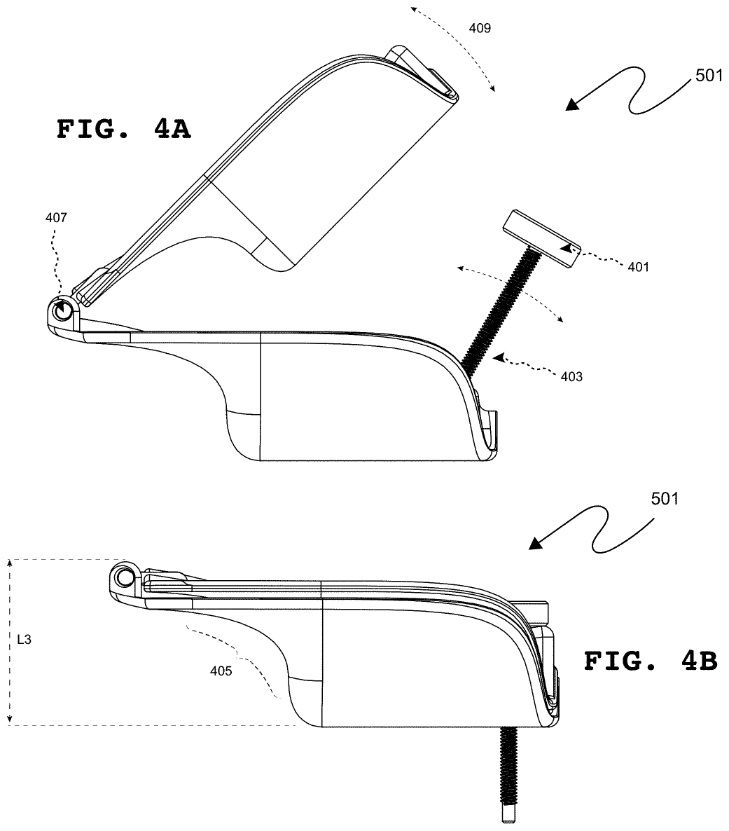

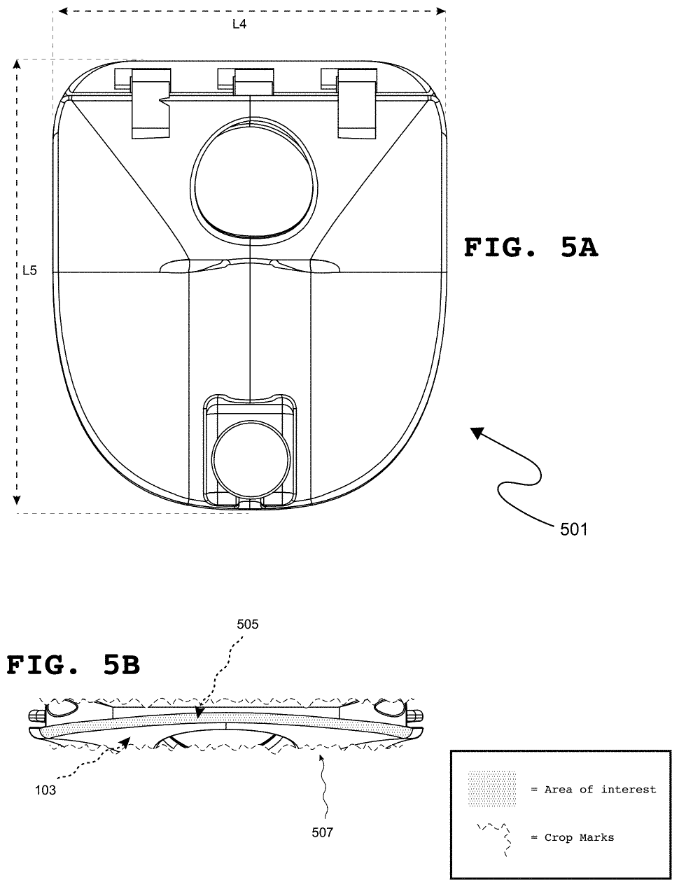

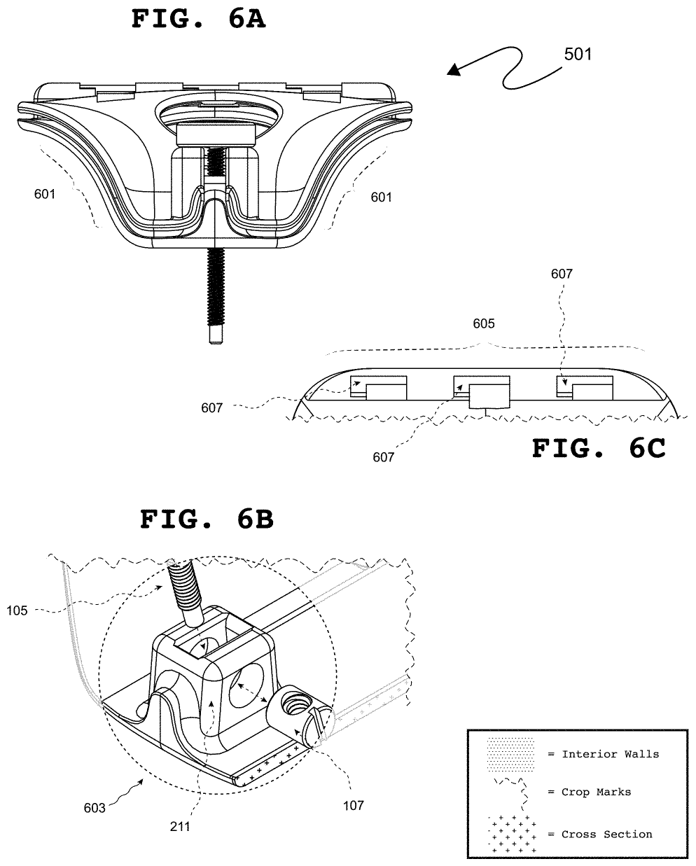

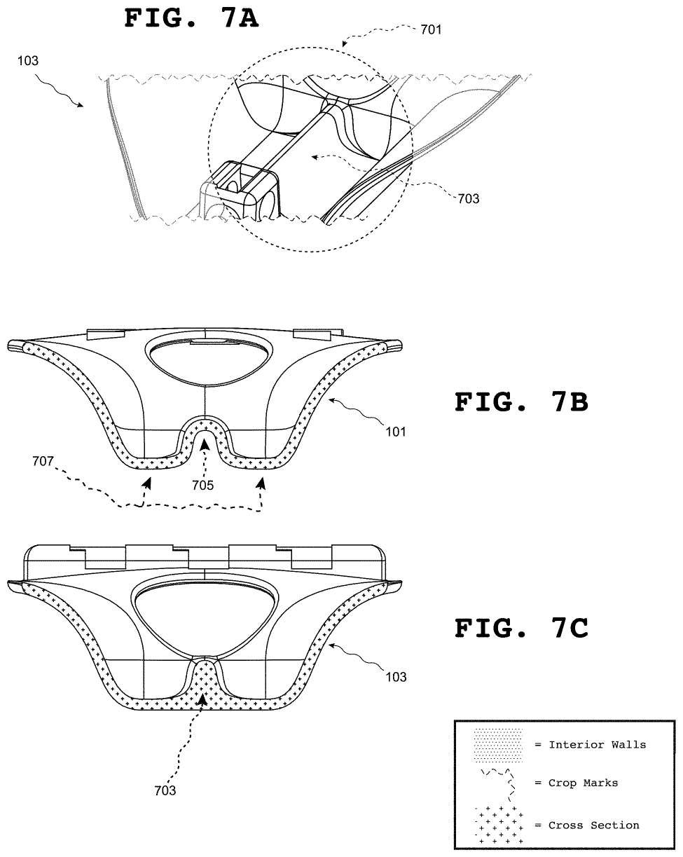

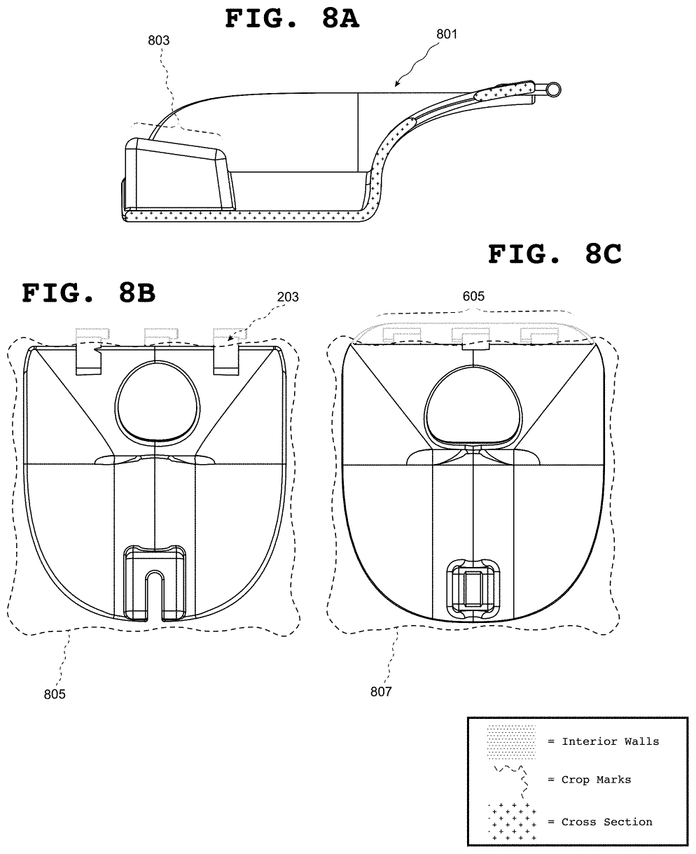

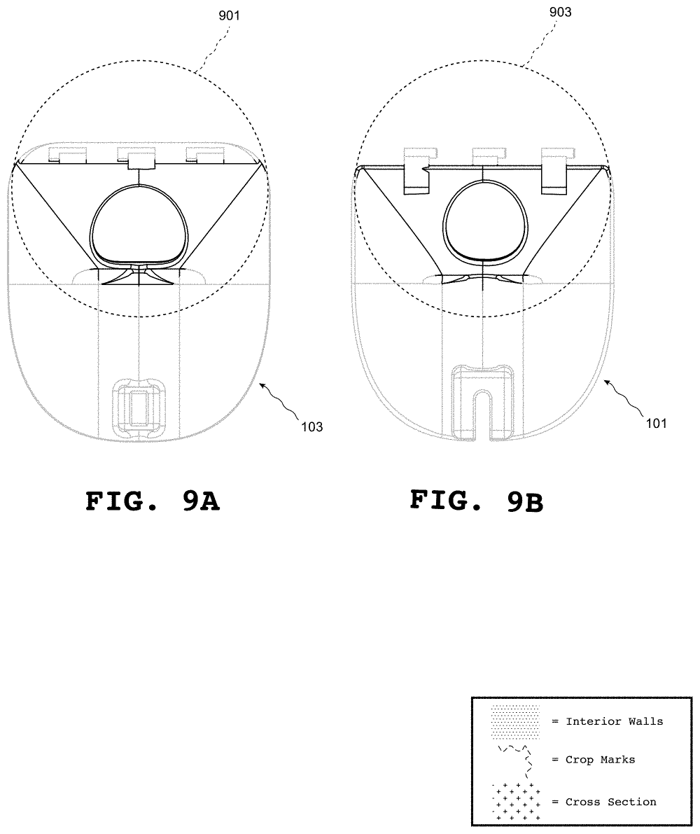

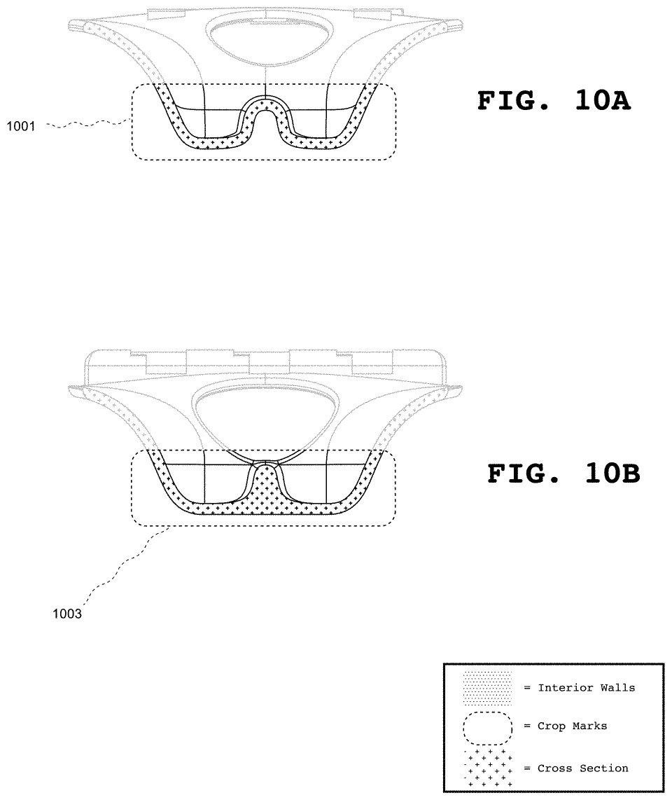

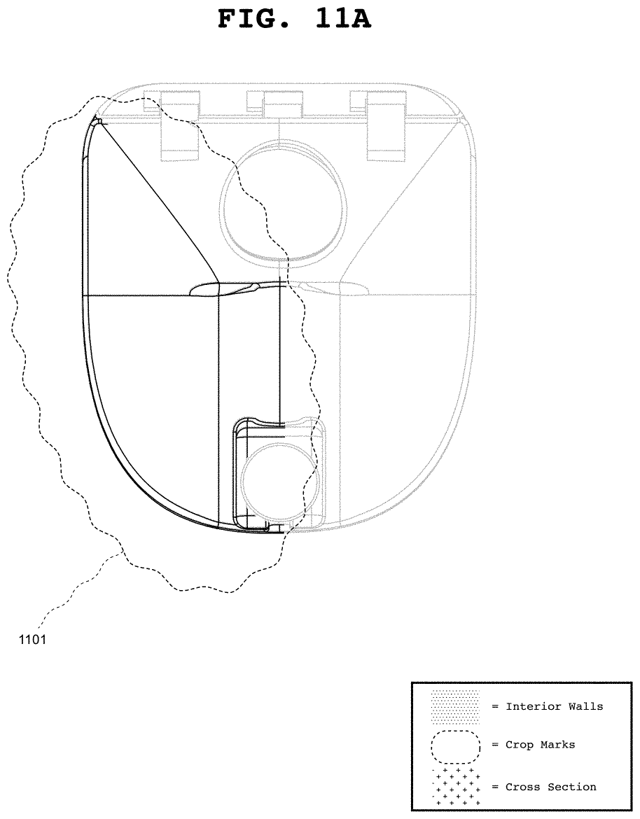

FIG. 3A-3B are illustrative diagrams of the top plate's cross-section 303 and the base plate's cross-section 305, viewed from the isometric perspective, 1:0.75 scale. The base plate's cross section 305 illustrates the clevis pivot bracket's internal structure 307. The top plate's cross section 303 illustrates the catch plate body's internal structure 309 which covers the clevis pivot bracket 211, FIG. 2B when the assembled device 501 is in the collateral position.

FIG. 4A is an illustrative diagram of the fully assembled device 501, viewed from the sagittal plane, 1:0.75 scale. The top plate 101 articulates around the base plate 103 on the interlocking hinge's 301 axis of rotation 409.

FIG. 4B is an illustrative diagram of the approximate overall depth of the fully assembled device 501, viewed from the sagittal plane, where L3 is approximately 53 millimeters, in the preferred embodiment.

FIG. 5A is an illustrative diagram of the approximate overall width and height of the fully assembled device 501, viewed from the anterior coronal plane, 1:0.75 scale, where L4 is approximately 127 millimeters, and L5 is approximately 148 millimeters, in the preferred embodiment.

FIG. 5B is an illustrative diagram of the fully assembled device's cross section 507, viewed from the superior transverse plane, 1:0.75 scale. The base plate 103 has hypogastric-ergonomic contouring 505 to reduce collision with the wearer's abdominal region.

FIG. 6A is an illustrative diagram of the fully assembled device 501, viewed from the inferior transverse plane, 1:0.75 scale. The top plate 101 and base plate 103 have adductor-ergonomic contouring 601 to match the contours of the wearer's thighs.

FIG. 6B is an illustrative diagram of the tensioning system 603, close-up view from the isometric perspective, 1.125:1 scale. The tensioning system 603 includes the clevis pivot bracket 211, the adjusting screw 105, the barrel nut 107, the catch plate body 213, FIG. 2A and it's retrocline lip 803, FIG. 8A.

FIG. 6C is an illustrative diagram of the horizontal assembly guide 605, section view from the coronal plane, 1:0.75 scale. The horizontal assembly guide 605 consists of female hinge pin furrows 607, which guide the male hinge pins 201 into the female hinge cups 407, FIG. 4A.

FIG. 7A is an illustrative cross section of the base plate 103, 1:0.75 scale, where the dashed circle highlights the posteriorly-elongated trough (also referred to herein as the “testicle cup”) 701 which cradles the testicles between the top plate and base plate. The testicle cup 701 has pubo-ergonomic contouring 405, FIG. 4B to reduce collision with the wearer's pubic region.

FIG. 7B-7C are illustrative cross-sections of the top plate 101 and base plate 103, viewed from the inferior transverse plane, 1:0.75 scale. The testicle divider 703, FIG. 7C, is the anterior vertical ridge at the center of the testicle cup's 701 base. This ridge 703 spans the length of the trough 701. The press relief 705, FIG. 7B, of the top plate 101 houses the testicle divider 703 when the plates are in the collateral position, thereby allowing the plates to lay flush against each other. The testicle press 707, FIG. 7B, of the top plate 101 presses the testicles into the testicle cup 701.

FIG. 8A is an illustrative diagram of the top plate's cross section 801, viewed from the sagittal plane, 1:0.75 scale, highlighting the retrocline lip 803.

FIG. 8B-8C are illustrative diagrams of the male hinge leaf 805, and the female hinge leaf 807, section view from the coronal plane, 1:0.50 scale. The male hinge leaf (herein also referred to as the “top plate's body”) 805 may be considered as any part of the top plate 101 that is inferior to the male hinge knuckles 203. The female hinge leaf (herein also referred to as the “base plate's body”) 807 may be considered as any part of the base plate 103 that is inferior to the hinge's horizontal assembly guide 605.

FIG. 9A is an illustrative diagram of the genital collar, section view 901, viewed from the sagittal plane, 1:0.75 scale. FIG. 9B is an illustrative diagram of the penile collar, section 903, viewed from the sagittal plane, 1:0.75 scale. In both cases, these collars are the superior medial faces of their respective plates. These collars have the approximate shape of posteriorly-arched isosceles triangles.

FIGS. 10A-10B are illustrations of the top plate's cross section 1001 and base plate's cross section 1003, viewed from the inferior transverse plane, 1:0.75 scale. The highlighted section of these drawings illustrate the jaws of the vice. The top plate's moveable jaw 1001 presses into the base plate's stationary jaw 1003.

FIG. 11A is a section view of one of the two inferior symmetrical faces, viewed from the anterior coronal plane, 1:0.75 scale. The left inferior symmetrical face 1101 and it's right counterpart are together referred to in this document as the “inferior symmetrical faces”.

### DESCRIPTION OF THE EMBODIMENTS

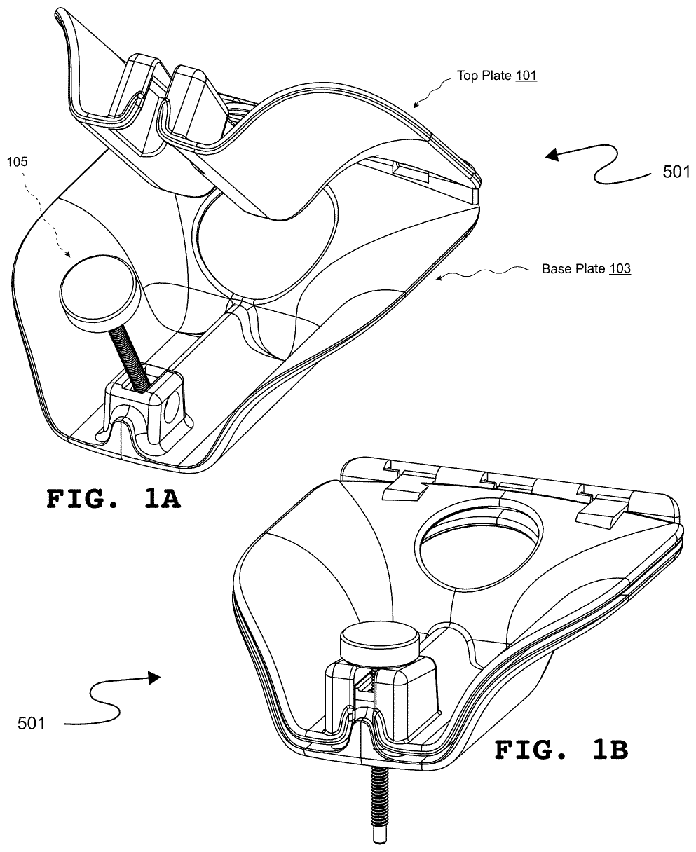

FIG. 1A provides a trimetric perspective of the fully assembled testicle compression device in accordance with the invention. In the preferred embodiment, the base plate 103 and the top plate 101 are compressed by means of an adjusting screw 105. This tensioning apparatus allows for a high degree of precision when dialing in a desired amount of pressure. It should be understood, however, that the compression action may be achieved by alternate designs without deviating from the scope or spirit of the invention.

In an alternate embodiment, the top and base plates may be compressed by means of a ratcheting tensioning system (not shown). While this system may offer different benefits, such as having a potentially smaller footprint or utilizing smaller components and thereby requiring less space and having fewer protruding components, the stepped increments of a ratcheting system will never have the same precision nor linear tensioning action as a screw/torsion-based system will. With such a delicate task as testicle compression, it is desirable to employ the highest degree of tensioning precision as is possible.

In the preferred embodiment, the top plate and base plate are hinged together by means of an integrated hinge, i.e. the components of the hinge are built into the design of the top and base plates. This design reduces the need for excessive hardware, providing the simplest possible method for assembling the vice. Additionally, the inclusion of a slip-joint in the integrated hinge allows for the plates to be separated with relative ease. This slip joint feature has multiple benefits. One of these benefits is that the disassembled plates can be sanitized more easily than a device with permanently hinged plates. Another benefit is that the application of the device to the wearer's body is achieved more easily by outfitting the device in stages. The detachable hinge allows the wearer to fasten the device to their genitals one plate at a time, starting by positioning the base plate on the wearer's body, and then subsequently attaching the top plate to the base plate, completing the hinge. As the top plate is not attached during the first stage of the assembly process, the top plate does not obstruct or interfere with the placement and application of the base plate. The base plate can be properly fitted, adjusted, and then the top plate can be subsequently attached, assembled, and properly fitted to the wearer.

In an alternate embodiment, the top and base plates are hinged together using a permanently fixed hinge (not shown). This alternate embodiment requires more hardware than the preferred embodiment and thus requires extra steps in the manufacturing process. In this alternate embodiment the top plate and base plate would be permanently connected to each other. The inability to disconnect and separate these hinges would make application of the device difficult and unwieldy.

In the preferred embodiment, the hinge is assembled by aligning the top plate perpendicular to the base plate, and then inserting the male hinge pins into the female pin alignment track. The device is now in the unlocked position. To interlock the top and base plates, slide the male hinge pins along the female pin alignment track into the female hinge cups until the pins are firmly seated. At this point, the male hinge knuckles have cleared the female gate curbs, and the hinge knuckles can be articulated radially towards the base plate, channeling the hinge knuckles in between the hinge gates, thereby preventing lateral shifting of the top plate, and locking the hinge pins within the hinge cups. The device is now in the locked/interlocked position.

In the preferred embodiment, FIG. 2A and FIG. 2B illustrate the respective orifices of the top and base plates, where the genitals are inserted. The dimensions L1 and L2 do not have specific values, rather, the only specification is that L1 is less than L2. In alternate embodiments, the overall size of the invention can be scaled up or down, in order to accommodate different shapes and sizes of a wearer's body. In these embodiments, it is possible for L1 and L2 to scale nonlinearly relative to the overall scale of the embodiment; therefore it is only necessary that the orifices 205 and 207 follow the rule L1 is less than L2, relative to the scale of the embodiment.

In the preferred embodiment, the base plate and top plate have offset orifice diameters to retain the testicles within the jaws of the vise. The major orifice 207 of the base plate 103 is large enough to allow insertion of both the penis and testicles, while the minor orifice 205 of the top plate 101 has a smaller opening, which only allows insertion of the penis, thereby preventing the testicles from escaping the vise.

In the preferred embodiment, the device's quick-disconnect hinge comprises three male hinge knuckles 203 which articulate within the female hinge knuckle gates 215. The horizontal assembly guide's 605 directionality has adverse polarity to the hinge's axis of rotation 409, FIG. 4A, which, when the male hinge knuckles are positioned inside the female hinge knuckle gates, creates a secure, interlocked connection between the base plate and top plate.

In alternate embodiments, it is possible to modify the number of hinge knuckles and hinge cups used to create the interlocking hinge assembly while still achieving the same general system and assembly. While it is possible to create a hinge with as little as one connection, the preferred embodiment utilizes three hinge knuckles and hinge cups for redundant stability and reinforcement. The left and right knuckles balance the hinge leafs alignment and rotation, while the middle knuckle relieves tension on the left and right knuckles, thereby reinforcing the overall strength of the system. In alternate embodiments, tighter design tolerances and/or stronger materials may yield the same interlocking hinge assembly with fewer male and female hinge components.

In the preferred embodiment, the base plate has a testicle divider 703, FIG. 7C, which helps separate the left and right testes into separate compartments. The testicle divider may be any form of partition that separates the left testis' from the right testis' compartments. In the preferred embodiment, the testicle divider is an anteriorly-protruding ridge that runs vertically up the middle of the base plate, starting from the clevis pivot bracket 211, FIG. 6B, extending to the base of the major orifice 207, FIG. 2B.

In an alternate embodiment, the base plate does not have a testicle divider.

In a second alternate embodiment, the testes may be separated into separate, ergonomically-contoured concavities. In this alternate embodiment, the testicles are divided not by any form of a ridge or other anterior protrusion, but inversely by the gravity of the depressions in this design. In this embodiment, the posteriorly-concaved compartments encourage the testes to situate themselves in their natural, symmetrical arrangement, with gravity acting as the force which allows the testes to sink into their respective compartments.

The illustration in 405, FIG. 4B is a depiction of the pubo-ergonomic contouring of the device. In the preferred embodiment, the shape of the genital collar 901, FIG. 9A follows the general contour of the wearer's pubic region. This contouring allows the genital collar to sit flush against the wearer's pubic region, effectively minimizing excessive pulling of the testicles from the body.

The illustration in 219, FIG. 2B is a depiction of rounding on the superior corners of the device. As these superior corners do not contact the wearer's legs, the amount of rounding here is not as critical to the invention as the rounding of the inferior corners are. In alternate embodiments, the superior corners may have more or less rounding, and/or comprise multi-radiused corners to achieve optimal comfort and conformity to the wearer's hypogastric region.

The illustration in 209, FIG. 2B is a depiction of the ambulo-ergonomic contouring of the device. In the preferred embodiment, the inferior corners are shaped with a logarithmic curve. As opposed to an algebraic (herein also referred to as “circular”) curve, logarithmic geometry has a more natural curve which compliments the motion of the wearer's thighs during ambulation. In alternate embodiments, the inferior corners may have larger or smaller radii, and/or the corner's profiles may consist of splines (defined herein as a line containing multiple curves), to further reduce impact upon the wearer's thighs.

The illustration in 505, FIG. 5B is a cross section of the hypogastric-ergonomic contouring of the device. The hypogastric-ergonomic contour helps relieve acute contact on the wearer's lower abdomen, distributing the point of contact more evenly around the curve of the lower abdomen, thereby producing a more comfortable fit.

In an alternate embodiment, the device does not have hypogastric-ergonomic contouring.

In an alternate embodiment, the superior edge 221, FIG. 2B of the device may have a scalloped profile on the coronal plane, matching the shape of a wearer whose belly is more pronounced.

In an alternate embodiment, the upper corners 219, FIG. 2B of the device may have multi-radiused fillets (also referred to herein as “corners”) to accommodate a wider variety of body shapes.

The illustration in 601, FIG. 6A is a depiction of the adductor-ergonomic contouring of the device. In the preferred embodiment, the device is contoured to reduce collision with the wearer's thighs. The vise's jaws 1001-1003, FIG. 10A-10B, are recessed between the wearer's thighs by means of an ergonomic, symmetrical shape that follows the contours of the inner thigh/adductor region. These two inferior symmetrical faces start at the anterior thigh and curve radially inward on the transverse plane, around the adductors, and intersect at the mid-sagittal plane, forming the general contour of a wearer's thigh gap.

In the preferred embodiment, the device comprises ambulo-ergonomic, pubo-ergonomic, hypogastric-ergonomic and adductor-ergonomic contouring. In an alternate embodiment (not shown), the device may utilize adductor-ergonomic and pubo-ergonomic contouring without the inclusion of ambulo-ergonomic and/or hypogastric-ergonomic contouring. In this alternate embodiment, the overall shape is still a posteriorly-elongated vice which conforms ergonomically to the general contours of a wearers adductor, hypogastric and pubic regions, and thereby sits flush against the wearers crotch, but in this alternate embodiment, the inferior corners do not have ergonomic curvature and/or the device may not be ergonomically contoured around the wearer's lower abdomen.

In an alternate, primitive embodiment (not shown), the overall shape of the device is a still a posteriorly-elongated vice that fits within the recess of the wearer's crotch, but the ergonomic contours are absent; replaced by their reduced geometric equivalents. In this primitive embodiment, the superior medial face and the two inferior symmetrical face's ergonomics are replaced with planar faces, and curvatures are replaced with hard angles and straight lines. This primitive embodiment still utilizes a basic shape that compliments the wearers crotch; the genital collar is still parallel to the symphyseal surface and the two inferior symmetrical faces are tangent to the adductor region. In this primitive embodiment, the design may be referred to as pubo-normal and adductor-tangent engineering, rather than pubo-ergonomic and adductor-ergonomic contouring.

In the preferred embodiment, the top and base plates are made of plastic, and the adjustment screw and the barrel nut are made of metal. In alternate embodiments, the top and base plates and the adjustment screw and barrel nut can be made of any combination of materials. These embodiments have different advantages and disadvantages over the preferred embodiment. For instance, an alternate embodiment where the top and base plates are made of chrome would give the wearer a more tactile sensory input from the feel of the metal, as metal is more conductive than plastic and therefore more sensitive to temperature changes. The chrome metal quality of this embodiment may be perceived as an advantage or disadvantage to the wearer, depending upon, among other factors, their sensitivity to temperature. The increase in weight of this chrome metal embodiment may also be considered an advantage or disadvantage to the wearer. This embodiment may be perceived as too bulky and/or heavy (a disadvantage), or, due to the cosmetic appearance of the polished, heavier chrome material, may be perceived as more fashionable and higher quality, therefore perceived as more desirable (an advantage).

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention which is set forth in the following claims.

What is claimed is:

1. A testicle stimulation device comprising: an ergonomically-shaped testicle vise that sits flush and conforms to the wearer's crotch; a single tensioning apparatus that engages the compression of the vise; a quick-disconnect hinge whose components are integrated into the vise's movable and stationary jaws; a testicle divider which separates the testicles into separate compartments of the vise.

2. The ergonomic shape of claim 1, wherein the inferior corners of the vise are significantly blunted

3. The ergonomic shape of claim 1, wherein the shape of the genital collar curves around the pubic region on the sagittal plane

4. The ergonomic shape of claim 1, wherein the shape of the genital collar curves around the hypogastric region on the transverse plane

5. The ergonomic shape of claim 1, wherein the shape of the testicle vise curves around the adductor region on the transverse plane

6. The tensioning apparatus of claim 1, wherein the stationary jaw and movable jaw are compressed by means of a single adjusting screw, wherein said adjusting screw is threaded into a swiveling nut

7. The adjusting screw of claim 6, wherein the head of the screw latches onto the movable jaw by means of a retrocline lip

8. The quick-disconnect hinge of claim 1, wherein the hinge is a slip-joint hinge, wherein the male hinge components are integrated into the design of one of the vise's jaws, and the female hinge components are integrated into the design of the vise's other jaw.

9. The female hinge components of claim 8, wherein said female hinge components include a pin alignment track, wherein said pin alignment track aligns the male hinge pins with the female hinge cups

10. The female hinge components of claim 8, wherein said female hinge components include hinge knuckle gates, wherein the male hinge knuckles articulate in and out of the female hinge knuckle gates, wherein the vise's hinge is securely interlocked when the male hinge knuckles are positioned inside the female hinge knuckle gates

11. The testicle divider of claim 1, wherein one or both of the vise's jaws has a ridge which distributes the left and right testes across the face of said jaws
